(19) United States
(12) Patent Application Publication
(10) Pub. No.: US 2007/0229481 A1
(43) Pub. Date: Oct. 4, 2007

(54) Scanning signal line driving device, liquid crystal display device, and liquid crystal display method

(75) Inventor: Hisashi Kodani, Hiroshima (JP)

Correspondence Address: HARNESS, DICKEY & PIERCE, P.L.C., P.O. BOX 8910, RESTON, VA, 20195, US

(73) Assignee: SHARP KABUSHIKI KAISHA

(21) Appl. No.: 11/723,102

(22) Filed: Mar. 16, 2007

(30) Foreign Application Priority Data
Mar. 20, 2006 (JP) 2006-077794

(51) Int. Cl. G09G 5/00

(52) U.S. Cl. 345/204

(57) ABSTRACT

The gate driver of the present invention operates so as to apply an image signal to a pixel when a start pulse signal having a short pulse length out of start pulse signals having different pulse lengths is inputted, and the gate driver operates so as to apply a black signal to the pixel when a start pulse signal having a long pulse length is inputted. This allows the liquid crystal display device to carry out impulse driving, cascade connection, and substrate-less driving.

This Nonprovisional application claims priority under 35 U.S.C. § 119(a) on Patent Application No. 077794/2006 filed in Japan on Mar. 20, 2006, the entire contents of which are hereby incorporated by reference.

### FIELD OF THE INVENTION

The present invention relates to (i) a scanning signal line driving device which is excellent in displaying a moving image, (ii) a liquid crystal display device having the scanning signal line driving device, and (iii) a liquid crystal display method of the liquid crystal display device.

### BACKGROUND OF THE INVENTION

Conventionally, various active matrix liquid crystal display devices have been developed and have been applied to a display section of a ward processor or a personal computer or to a television and the like.

FIG. 6 illustrates an arrangement of a liquid crystal display device 150 as an example of the conventional active matrix liquid crystal display device.

As illustrated in FIG. 6, the liquid crystal display device 150 includes a liquid crystal panel 105, a control circuit 110, a plurality of source drivers 111 (four source drivers herein), a plurality of gate drivers 112 (three gate drivers herein), a source side substrate 120, and a gate side substrate 130.

The gate drivers 112 are connected in cascade manner so that: when a certain gate driver finishes operating, the gate driver sends an operation completion signal, indicative of completion of operation, to a gate driver at the following stage, so that the gate driver at the following stage begins operating.

Further, as apparent from FIG. 6, a source driver control signal and image data are supplied from the control circuit 110 via the source side substrate 120 to the respective source drivers 111. Likewise, a gate driver control signal is supplied from the control circuit 110 via the gate side substrate 130 to the respective gate drivers 112.

Recently, the market further requires liquid crystal display devices to have smaller sizes, so that liquid crystal display devices each of which has neither the source side substrate nor the gate side substrate (hereinafter, referred to as “liquid crystal display device which carries out substrate-less driving”) have been developed. Patent Document 1 (Japanese Unexamined Patent Publication No. 297394/1993 (Tokukaihei 5-297394)(Publication date: Nov. 12, 1993)) discloses a liquid crystal display device which carries out the substrate-less driving by causing a driver to output a signal, having been inputted to the driver, to a driver at the following stage.

Also, liquid crystal display devices are further required to have higher display quality.

Once an image signal for displaying an image is applied to a pixel provided on a liquid crystal panel of the liquid crystal display device, the pixel keeps the applied image signal until another image signal is newly applied thereto. Thus, a human visual line traces a moving image, which results in occurrence of a residual image on a retina, so that quality of the display image drops.

Thus, in order to solve the problem, there was proposed impulse driving in which an image signal and a black signal (image signal which causes the pixel to make a dark display) are applied in a single frame so as to darken the image after making a display so that the retina is free from any residual image. Various liquid crystal display devices each of which carries out the impulse driving are proposed. Patent Document 2 (Japanese Unexamined Patent Publication No. 60078/2001 (Tokukai 2001-60078)(Publication date: Mar. 6, 2001)) discloses a liquid crystal display device which simultaneously drives a gate driver for applying an image signal and a gate driver for applying a black signal in a single frame so as to carry out the impulse driving.

More specifically, first, the source driver of Patent Document 2 outputs the image signal and the black signal in a time sharing manner. Further, driving clock signals whose phases are deviated from each other by a half cycle for each gate driver are applied to the gate drivers. For example, a phase of a driving clock signal applied to a second gate driver is deviated from a phase of a driving clock signal applied to a first gate driver by half cycle. According to this arrangement, a scanning signal is outputted from the first gate driver so as to apply the image signal, and a scanning signal is outputted from the second gate driver so as to apply the black signal, and a scanning line to which the image signal is applied and a scanning line to which the black signal is applied are simultaneously driven, thereby carrying out the impulse driving.

Further, Patent Document 2 discloses means for securing a black applying period by outputting a plurality of scanning signals from a gate driver for applying the black signal in case where the black applying period is shorter due to setting of an image applying period. In this case, a switching terminal is provided on each gate driver and an identification signal is applied to the switching terminal so as to switch between outputting of plural scanning signals and outputting of a single scanning signal.

As described above, in Patent Document 2, the impulse driving is carried out by deviating phases of the driving clock signals respectively applied to the gate drivers from each other. Thus, it is necessary to input control signals (a driving clock signal and a start pulse signal) for each gate driver. In other words, a control system for carrying out normal driving and a control system for carrying out the impulse driving are different from each other. Thus, the arrangement of Patent Document 2 raises such a problem that it is impossible to carry out the cascade connection and the substrate-less driving.

### SUMMARY OF THE INVENTION

The present invention was made in view of the foregoing problems, and an object of the present invention is to realize a gate driver which allows plural gate drivers to share a control signal so as to carry out impulse driving, i.e., to realize a scanning signal line driving device, a liquid crystal display device, and a liquid crystal display method of the liquid crystal display device, each of which allows not only the impulse driving but also cascade connection and substrate-less driving.

Hereinafter, in case of describing various kinds of signals applied to the scanning signal line driving device, these signals are generically referred to as “control signal”.

In order to achieve the foregoing object, a gate driver according to the present invention includes a shift register for shifting an inputted start pulse signal at a timing of an inputted driving clock signal, said scanning signal line driving device controlling a switching element, which becomes on in response to a signal outputted from the shift register and provides a pixel of a display device with an image signal for changing luminance of the pixel, so as to turn on or turn off the switching element, wherein: the switching element is turned on so as to provide an image signal for displaying an image to the pixel when a first start pulse signal is inputted as the start pulse, the switching element is turned on so as to provide an image signal for causing the pixel to make a dark display to the pixel when a second start pulse signal is inputted as the start pulse signal, and the driving clock signal rises or drops during an active period of the start pulse signal, and the driving clock signal rises or drops plural times during an active period of the second start pulse signal.

The scanning signal line driving device according to the present invention is arranged so as to be capable of operating differently for each start pulse signal when a plurality of start pulse signals having different pulse lengths are inputted. Specifically, the scanning signal line driving device turns on the switching element, provided on the pixel of the display device, so as to cause the pixel to make a normal display (image display) when the first start pulse signal is inputted, and so as to cause the pixel to make a dark display when the second start pulse signal is inputted.

For example, suppose that an image signal for causing the pixel to display an image and an image signal for causing the pixel to make a dark display are supplied to the pixel in a time sharing manner. The scanning signal line driving device can turn on the switching element during a period in which the image signal for causing the pixel to display an image is provided when the first start pulse signal is inputted. As a result, as described above, the scanning signal line driving device allows the pixel to make a normal display when the first start pulse signal is inputted.

Meanwhile, the scanning signal line driving device can turn on the switching element during a period in which the image signal for causing the pixel to make a dark display is provided when the second start pulse signal is inputted. As a result, as described above, the scanning signal line driving device allows the pixel to make the dark display when the second start pulse signal is inputted.

Thus, by inputting the first start pulse signal and the second start pulse signal alternately, it is possible to carry out the impulse driving which allows the normal display and the dark display repeatedly. That is, the scanning signal line driving device can carry out the impulse driving merely by utilizing a pulse length difference between the start pulse signals (it is not necessary to input the control signal for each scanning signal line driving device). Further, according to the foregoing arrangement, it is possible to carry out only the normal display when only the first start pulse signal is inputted. That is, a control signal can be shared in both the impulse driving and the normal driving (only the normal display).

As a result, it is possible to realize a scanning signal line driving device which allows plural scanning signal line driving devices to share a control signal so as to carry out impulse driving, i.e., to realize a scanning signal line driving device which allows not only the impulse driving but also cascade connection and substrate-less driving.

Further, as described above, a control signal can be shared in both the impulse driving and the normal driving, so that it is possible to easily switch between the impulse driving and the normal driving.

In order to achieve the foregoing object, a liquid crystal display device according to the present invention includes the aforementioned scanning signal driving device and a control circuit for outputting the signal indicative of the blanking period to the scanning signal line driving device as well as the first start pulse signal or the second start pulse signal.

The liquid crystal display device according to the present invention is arranged in the foregoing manner. Thus, the liquid crystal display device can carry out the impulse driving merely utilizing a pulse length difference between the start pulse signals. Further, a control signal can be shared in both the impulse driving and the normal driving (only the normal display). As a result, it is possible to realize the liquid crystal display device which allows not only the impulse driving but also the cascade connection and the substrate-less driving.

Further, the scanning signal line driving device of the liquid crystal display device can easily switch between the impulse driving and the normal driving as described above. Thus, for example, in case of mainly displaying moving images in a television and the like, the impulse driving is carried out, and in case of mainly displaying still images in a personal computer and the like, the normal driving is carried out. In this manner, it is possible to easily switch the driving mode. As a result, in addition to the aforementioned effect, the liquid crystal display device can improve the display quality with a simple arrangement according to the purpose of use.

In order to achieve the foregoing object, the liquid crystal display method according to the present invention for causing the liquid crystal display device to make a display includes the steps of: causing the control circuit to provide only the first start pulse signal to the scanning signal line driving device in carrying out normal driving which allows only an image display; and causing the control circuit to provide the first start pulse signal and the second start pulse signal alternately to the scanning signal line driving device in carrying out impulse driving which allows the image display and the dark display repeatedly.

According to the foregoing method, the liquid crystal display device can carry out the impulse driving merely by utilizing a pulse length difference between the start pulse signals. Further, a control signal can be shared in both the impulse driving and the normal driving (only the normal display). As a result, it is possible to realize the liquid crystal display method for making a display in the liquid crystal display device which allows not only the impulse driving but also the cascade connection and the substrate-less driving.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a diagram illustrating an arrangement of a liquid crystal display device according to the present embodiment.

FIG. 2 is a circuit diagram illustrating an example of an arrangement of a gate driver.

FIG. 3 is a timing chart illustrating operation timings of circuits provided on the gate driver in case where the one of start pulse signals is inputted.

FIG. 4 is a timing chart illustrating operation timings of circuits provided on the gate driver in case where the other of start pulse signals is inputted.

FIG. 5 is a timing chart illustrating operation timings of the gate driver in case where the gate driver carries out impulse driving.

FIG. 6 is a diagram illustrating an arrangement of a conventional liquid crystal display device.

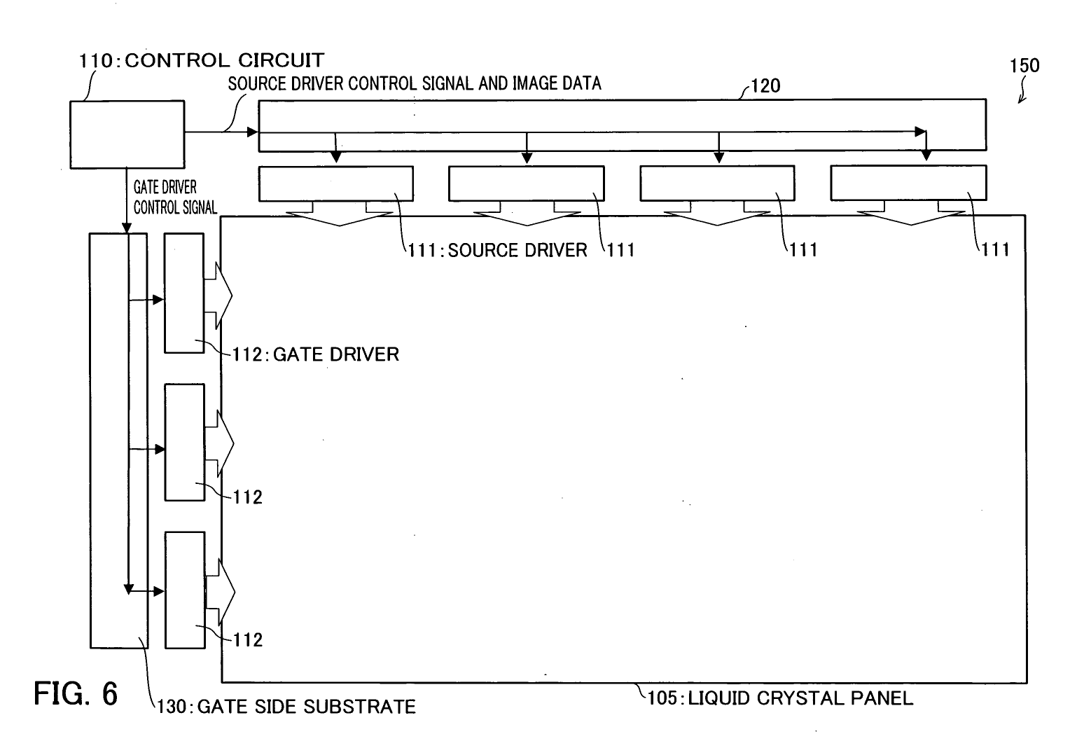

### DESCRIPTION OF THE EMBODIMENTS

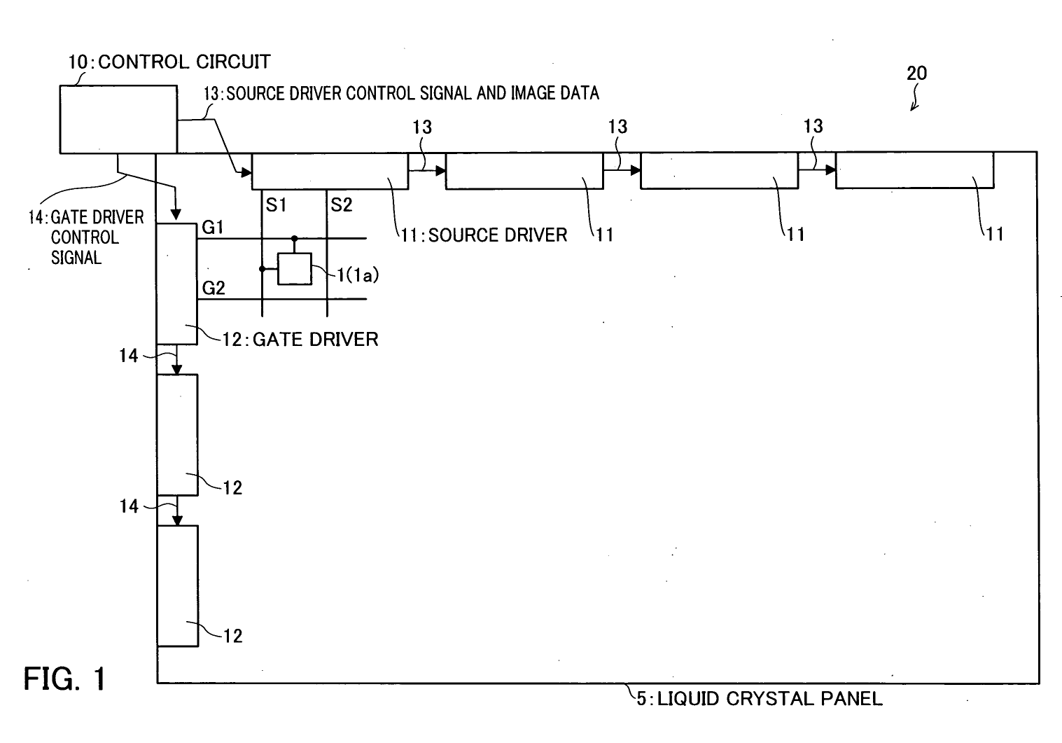

The following description will explain an embodiment of the present invention with reference to FIGS. 1 to 5.

FIG. 1 illustrates an arrangement of a liquid crystal display device 20 according to the present embodiment. As illustrated in FIG. 1, the liquid crystal display device 20 includes a liquid crystal panel 5, a control circuit 10, a plurality of source drivers 11 (four source drivers herein), and a plurality of gate drivers (scanning signal line driving devices) 12 (three gate drivers herein).

The liquid crystal panel 5 includes a plurality of data signal lines S (only data signal lines S1 and S2 are indicated in FIG. 1) and a plurality of scanning signal lines G (only scanning signal lines G1 and G2 are indicated in FIG. 1) which respectively cross the data signal lines S. Further, a pixel 1 is provided so as to correspond to a combination of (i) a pair of data signal lines S and a pair of scanning signal lines G, specifically, the pixel 1 is provided on a portion surrounded by two data signal lines S adjacent to each other and two scanning signal lines G adjacent to each other (FIG. 1 indicates only a pixel 1a disposed in a portion surrounded by data signal lines S1 and S2 and scanning signal lines G1 and G2).

Further, the pixel 1 includes a plurality of TFTs (switching elements: not shown) each of which has a gate connected to each scanning signal line G, a source connected to each data signal line S, and a drain connected to each pixel electrode. Note that, the pixel electrode is connected to a counter electrode via a liquid capacitor. Note that, hereinafter, an “image signal D” refers to an image signal for causing an the pixel 1 to display an image, and a “black signal B” refers to an image signal for causing the pixel 1 to make a dark display. In case of describing the image signal D and the black signal B, these signals are generically referred to as “image signal”.

The control circuit 10 supplies source driver control signals (a driving clock signal, a start pulse signal, and the like) and image data 13 to the source driver 11 at the first stage, and supplies gate driver control signals (a driving clock signal CLS, a start pulse signal GSP, an image timing signal OE, and the like) 14 to a gate driver 12 at the first stage. Here, the control circuit 10 supplies two types of start pulse signals GSP.

The two types of start pulse signals GSP have pulse lengths different from each other. Specifically, out of the two types of start pulse signals GSP, the one start pulse signal GSP (hereinafter, referred to as “start pulse signal GSP1)(first start pulse signal) has such pulse length and phase that the driving clock signal CLS rises once in its H (high) (active) period.

Meanwhile, the other start pulse signal GSP (hereinafter, referred to as “start pulse signal GSP2”)(second start pulse signal) has such pulse length and phase that the driving clock signal CLS rises plural times (twice in the present embodiment) in its H (high) (active) period. Note that, the start pulse signal GSP2 is not limited to the aforementioned signal, but any signal may be used as the start pulse signal GSP2 as long as the signal is such that the driving clock signal CLS rises plural times sequentially during the H period of the start pulse signal GSP2. Further, the active period of the two types of start pulse signals GSP is, in other words, a period which causes a shift register 21 (described later) of the gate driver 12 to recognize beginning of the operation.

The image timing signal OE is a signal indicative of a timing at which the source driver 11 outputs an image signal. In the present embodiment, the black signal B is applied to each data signal line S of the liquid crystal panel 5 during an L (low) period in which the image timing signal OE is low. Note that, in the L period of the image timing signal OE, its pulse width is set so that the L period is equal to a horizontal blanking period of pulse driving. Thus, the L period of the image timing signal OE is, in other words, a signal indicative of the blanking period.

In accordance with a source driver control signal 13A supplied from the control circuit 10, the source driver 11 samples image data corresponding to a single horizontal period from image data 13B supplied from the control circuit 10 so that the sampling is carried out at a predetermined timing, and carries out extraction thereof, and carries out digital/analog conversion so as to generate an image signal D. Further, the control circuit 10 supplies the black signal B as the image data 13B to the source driver 11. In accordance with the source driver control signal 13A, the source driver 11 outputs the image signal D and the black signal B, which have been subjected to digital/analog conversion, to each data signal line S. In the case of the present embodiment, as described above, the source driver 11 outputs the black signal B during the L period of the image timing signal OE and outputs the image signal D during the H period of the image timing signal OE.

In accordance with a gate driver control signal 14 supplied from the control circuit 10, the gate drivers 12 sequentially select the respective scanning signal lines G (each gate driver 12 provides a scanning signal (below-described output signal OG) which causes each TFT connected to each scanning signal line G to be ON). As a result, a plurality of TFTs connected to the selected scanning signal lines G become conductive, so that the image signal outputted from the source driver 11 is provided to each pixel 1. By carrying out such operation repeatedly, it is possible to display an image. Note that, an analog voltage obtained by performing digital/analog conversion with respect to the image signal is applied to the pixel 1, but this condition is expressed as “the image signal is applied to the pixel 1” in the present embodiment.

In case of the present embodiment, any one of the aforementioned two types of start pulse signals GSP is inputted to the gate driver 12, and the gate driver 12 operates differently for each start pulse signal GSP. As a result, it is possible to select the scanning signal line G so as to carry out the impulse driving. This is detailed as follows.

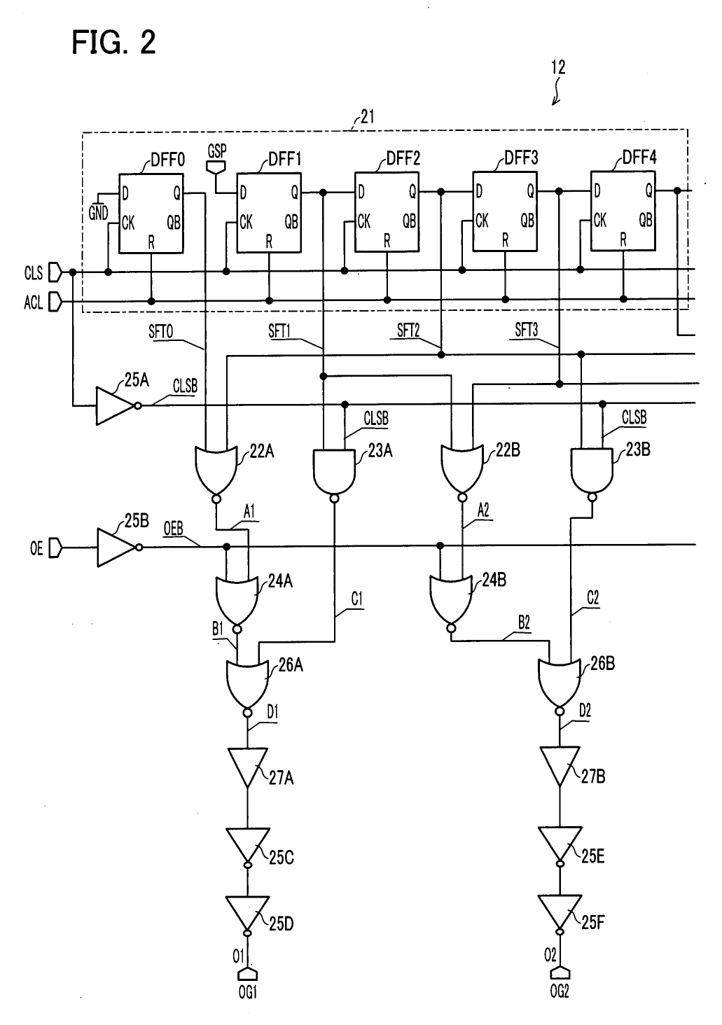

FIG. 2 illustrates an example of an arrangement of the gate driver 12. Note that, the following description explains the arrangement and operation of the gate driver 12, but the explanation is given by taking as an example a case where output signals OG1 and OG2 each of which is an output signal OG (scanning signal) of the gate driver 12 are outputted.

As illustrated in FIG. 2, the gate driver 12 includes a shift register 21, NOR circuits 22, 24, and 26, a NAND circuit 23, an inverter 25, and a level shifter 27.

The shift register 21 includes D flip flop circuits (hereinafter, referred to as “DFF”) whose number exceeds the number of outputs of the gate driver 12 by one. Five DFFs (DFF0 to DFF4) are provided herein.

A GND level is inputted to an input terminal D of the DFF0, and any one of the two types of start pulse signals GSP supplied from the control circuit 10 is inputted to an input terminal D of the DFF1. An output of the DFF1 previous to the DFF 2 is inputted to the DFF 2. An output of the DFF2 previous to the DFF 3 is inputted to the DFF 3. An output of the DFF3 previous to the DFF 4 is inputted to the DFF 4. Further, a reset signal ACL supplied from the control circuit 10 is inputted to a reset (R) input of each DFF, and the driving clock signal CLS supplied from the control circuit 10 is inputted to a clock (CK) input of each DFF.

Each DFF outputs a value, inputted to its input terminal D, from its output terminal Q when the driving clock signal CLS inputted to the clock input rises. Thus, the GND level is always outputted via the output of the DFF0, and the start pulse signal GSP level is outputted via the output of the DFF1. The outputs of the DFFs 1 to 3 respectively previous to the DFFs 2 to 4 are outputted via the outputs of the DFF2 to DFF4 as described above, thereby carrying out operation of the shift register.

The output terminal Q of the DFF0 is connected to the NOR circuit 22A as well as an output terminal Q of the DFF2, and an output terminal Q of the DFF1 is connected to the NOR circuit 22B as well as an output terminal Q of the DFF3. An output terminal Q of the DFF4 is connected to another NOR circuit 22 (not shown) as well as the output terminal Q of the DFF2. That is, output terminals Q of two DFFs which are positioned with other DFF intervening therebetween are connected to the same NOR circuit 22.

The output terminal Q of the DFF1 is connected to the NAND circuit 23A, and the output terminal Q of the DFF2 is connected to the NAND circuit 23B, and the output terminal Q of the DFF3 is connected to another NAND circuit 23 (not shown). An output terminal of an inverter 25A to which the driving clock signal CLS has been inputted is connected to each NAND circuit 23.

An output terminal of the NOR circuit 22A is connected to the NOR circuit 24A, and an output terminal of the NOR circuit 22B is connected to the NOR circuit 24B. An output terminal of an inverter 25B to which the image timing signal OE has been inputted is connected to each NOR circuit 24.

An output terminal of the NOR circuit 24A is connected to the NOR circuit 26A as well as an output terminal of the NAND circuit 23A, and an output terminal of the NOR circuit 24B is connected to the NOR circuit 26B as well as an output terminal of the NAND circuit 23B.

An output terminal of the NAND circuit 26A is connected to an output terminal O1 (terminal via which the output signal OG1 is outputted) of the gate driver 12 via the level shifter 27A, the inverter 25C, and the inverter 25D. An output terminal of the NOR circuit 26B is connected to an output terminal O2 (terminal via which the output signal OG2 is outputted) of the gate driver 12 via the level shifter 27B, the inverter 25E, and the inverter 25F.

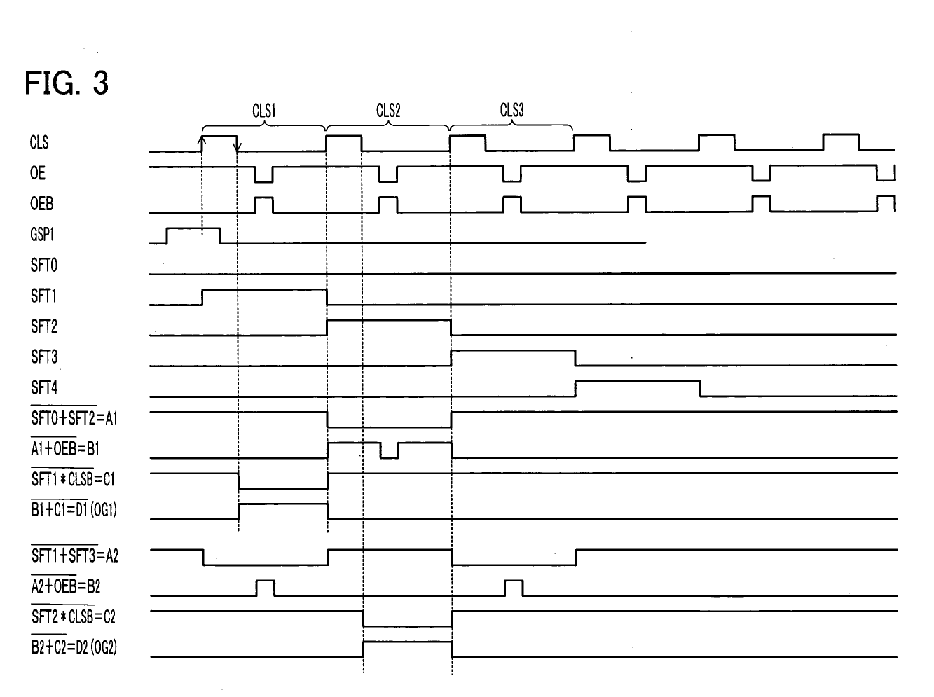

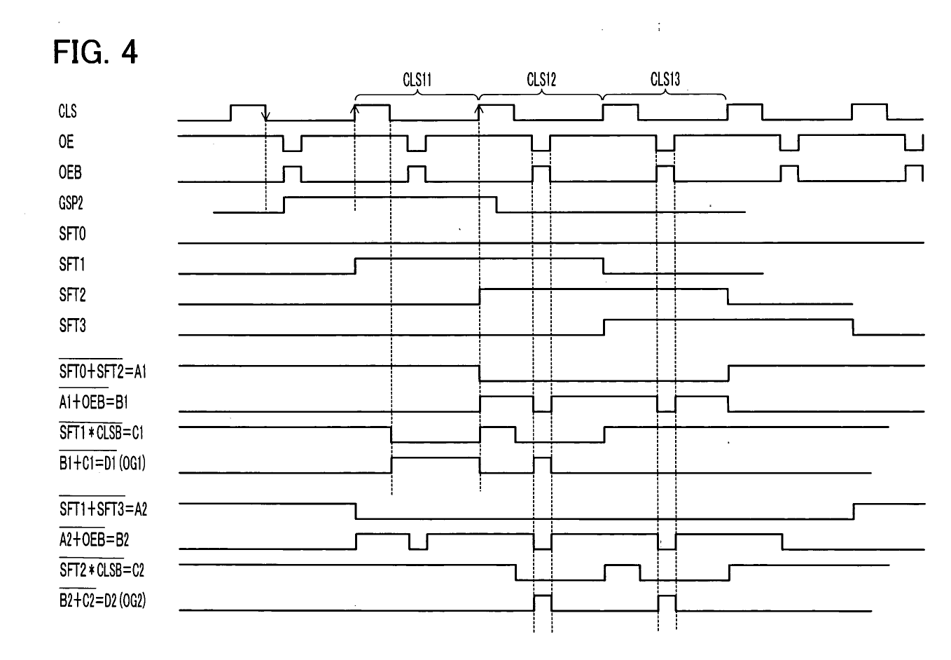

Next, with reference to FIG. 3 and FIG. 4, operation of the gate driver 12 arranged in the foregoing manner is described as follows. First, with reference to FIG. 3, operation of the gate driver 12 in case where the start pulse signal GSP1 is inputted to the gate driver 12 is described.

FIG. 3 illustrates timings at which circuits of the gate driver 12 operate in this case. Note that, a signal OEB of FIG. 3 is an output signal of the inverter 25B, and signals SFT0 to SFT4 of FIG. 3 are output signals of the DFF0 to the DFF4. Further, in FIG. 3, a signal A1 is an output signal of the NOR circuit 22A, a signal B1 is an output signal of the NOR circuit 24A, a signal C1 is an output signal of the NAND circuit 23A, and a signal D1 is an output signal of the 26A. Further, in FIG. 3, a signal A2 is an output signal of the NOR circuit 22B, a signal B2 is an output signal of the NOR circuit 24B, a signal C2 is an output signal of the NAND circuit 23B, and a signal D2 is an output signal of the NOR circuit 26B.

As illustrated in FIG. 3, when the start pulse signal GSP1 is inputted and the driving clock signal CLS1 rises, the shift register 21 begins operating, so that only the output signal SFT1 of the DFF1 has an H level. At this time, the output signal SFT0 of the DFF0 already has an L level before the previous driving clock signal CLS rises. Further, output signals of other circuits are illustrated in FIG. 3. Note that, the shift register 21 shifts signals sequentially from DFF1 as illustrated in FIG. 3.

When the driving clock signal CLS1 drops, only the output signal C1 of the NAND circuit 23A varies so as to have an L level (as illustrated in FIG. 3, signals of other circuits do not vary from a state at the time when the driving clock signal CLS1 rises). As a result, the output signal D1 of the NOR circuit 26A has an H level. Note that, the output signal D2 of the NOR circuit 26B has an L level.

Next, when the driving clock signal CLS2 rises, the output signal SFT1 of the DFF1 has an L level, and the output signal SFT2 of the DFF2 has an H level. At this time, the output signal A1 of the NOR circuit 22A has an L level, the output signal C1 of the NAND circuit 23A has an H level, and the output signal B1 of the NOR circuit 24A has an H level. As a result, the output signal D1 of the NOR circuit 26A has an L level. That is, an H period of the output signal D1 of the NOR circuit 26A corresponds to an L level of the driving clock signal CLS1.

At this time, the output signal D2 of the NOR circuit 26B still has the L level. However, during a period from drop of the driving clock signal CLS2 to rise of the driving clock signal CLS3, the output signal D2 of the NOR circuit 26B has an H level. That is, an H period of the output signal D2 of the NOR circuit 26B corresponds to an L period of the driving clock signal CLS2.

In the gate driver 12, a level of the output signal of the NOR circuit 26 is shifted to an operation voltage of the TFT by the level shifter 27 and is subsequently outputted via two inverters 25 as an output signal OG of the gate driver 12. That is, an H period of the output signal of the NOR circuit 26 corresponds to an L period of the driving clock signal CLS.

That is, in case where the start pulse signal GSP1 is inputted, the gate driver 12 of the present embodiment sequentially outputs the output signals OG each of which has an H level during the same period as the L period of the driving clock signal CLS (the H period of the output signal OG1 of the gate driver 12 corresponds to the L period of the driving clock signal, and the H period of the output signal OG2 of the gate driver 12 corresponds to the L period of the driving clock signal CLS2). The L period of the driving clock signal CLS overlaps the H period of the image timing signal OE indicative of a timing at which the image signal D is outputted from the source driver 11, so that the start pulse signal GSP1 is inputted to the gate driver 12, thereby applying the image signal D to the pixel 1 of the liquid crystal panel 5.

Here, as illustrated in FIG. 3, a period of a previous line image timing signal OE overlaps the H period of the output signal OG. For example, the H period of the output signal OG2 overlaps a period in which an image signal for a pixel connected to a TFT turned ON by the output signal OG1 is outputted from the source driver 11. Thus, the image signal for the pixel connected to the TFT turned ON by the output signal OG1 is applied to a pixel connected to a TFT turned ON by the output signal OG2 for a brief flash. However, as illustrated in FIG. 3, the image signal D for the pixel connected to the TFT turned ON by the output signal OG2 is sufficiently applied shortly after the foregoing application, so that there is no problem.

Next, with reference to FIG. 4, the following description explains operation of the gate driver 12 in case where the start pulse signal GSP2 is inputted to the gate driver 12.

FIG. 4 illustrates timings at which circuits of the gate driver 12 in this case operate. Note that, a signal OEB of FIG. 4 is an output signal of the inverter 25B, and signals SFT0 to SFT3 of FIG. 4 are output signals of the DFF0 to the DFF3 respectively. Further, in FIG. 4, a signal A1 is an output signal of the NOR circuit 22A, a signal B1 is an output signal of the NOR circuit 24A, a signal C1 is an output signal of the NAND circuit 23A, and a signal D1 is an output signal of the NOR circuit 26A. Further, in FIG. 4, a signal A2 is an output signal of the NOR circuit 22B, a signal B2 is an output signal of the NOR circuit 24B, a signal C2 is an output signal of the NAND circuit 23B, and a signal D2 is an output signal of the NOR circuit 26B.

As illustrated in FIG. 4, when the start pulse signal GSP2 is inputted and a driving clock signal CLS11 rises, the shift register 21 begins operating, so that only an output SFT1 of the DFF1 has an H level. At this time, an output SFT0 of the DFF0 already has an L level before the previous driving clock signal CLS rises. Further, output signals of other circuits are as illustrated in FIG. 4.

The shift register 21 shifts signals as illustrated in FIG. 4 in a sequential manner from the DFF1. Here, as described above, during the H period of the start pulse signal GSP2, the driving clock signal CLS rises twice (here, this includes rise of the driving clock signal CLS11 and rise of the driving clock signal CLS12), so that the H period of the output signal of each DFF corresponds to two cycles of the driving clock signal CLS. Thus, the H period of the output signal of the DFF overlaps the H period of the output signal of the previous DFF, and the overlapping period corresponds to a single cycle of the driving clock signal CLS.

When the driving clock signal CLS11 drops, only the output C1 of the NAND circuit 23A varies so as to have an L level (an output of each of other circuits keeps a state at the time of rise of the driving clock signal CLS11 as illustrated in FIG. 4). As a result, the output D1 of the NOR circuit 26A has an H level. Note that, the output D2 of the NOR circuit 26B has an L level.

Next, when the driving clock signal CLS12 rises, the output signal SFT1 of the DFF1 still has the H level and the output signal SFT2 of the DFF2 still has the H level. At this time, the output signal A1 of the NOR circuit 22A has an L level, the output signal C1 of the NAND circuit 23A has an H level, and the output signal B1 of the NOR circuit 24A has an H level. As a result, the output signal D1 of the NOR circuit 26A has an L level. As in the case where the aforementioned start pulse signal GSP1 is inputted to the gate driver 12, the H period of the output signal D1 of the NOR circuit 26A corresponds to the L period of the driving clock signal CLS11. Note that, the output signal D2 of the NOR circuit 26B still has the L level.

At this time, the L period of the image timing signal OE overlaps the L period of the driving clock signal CLS11 as illustrated in FIG. 4. However, this state is the same as in the case where the start pulse signal GSP1 is inputted to the gate driver 12 (out of the DFFs, only one DFF has an output signal whose level is high), the L period of the image timing signal OE has no influence on the output signal D1 of the NOR circuit 26A (first signal of the output signal OG1).

Next, after the driving clock signal CLS12 drops, out of the DFFs, there are some DFFs having output signals whose H periods overlap each other as described above. As a result, the L period of the image timing signal OE is available, so that the output signal D of the NOR circuit 26 having an H level during the same period as the L period of the image timing signal OE, i.e., the output signal OG of the gate driver 12 is outputted.

That is, in case where the start pulse signal GSP2 is inputted, the gate driver 12 of the present embodiment sequentially outputs the output signal OG having the H level during the same period as the L period of the image timing signal OE twice for every scanning signal line (since the driving clock signal CLS rises twice in the H period of the start pulse signal GSP2) (except for the first signal of the output signal OG1). As a result, it is possible to apply the black signal B to the pixel 1 of the liquid crystal panel 5.

As described above, the two types of start pulse signals GSP are inputted to the gate driver 12 of the present embodiment, and the gate driver 12 operates differently for each start pulse signal GSP. Specifically, when the start pulse signal GSP1 is inputted, the output signal OG is outputted so as to apply the image signal D to the pixel 1 (so as to make a normal display). Meanwhile, when the start pulse signal GSP2 is inputted, the output signal OG is outputted so as to apply the black signal B to the pixel 1 (so as to make a dark display). Thus, when the start pulse signal GSP1 and the start pulse signal GSP2 are alternately inputted, the gate driver 12 carries out the impulse driving which causes the normal display and the dark display to be alternately made.

In the present embodiment, the start pulse signal GSP1 is inputted once and also the start pulse signal GSP2 is inputted once in an alternating manner so as to carry out the impulse driving, but it may be so arranged that, for example, the start pulse signal GSP1 is inputted twice and the start pulse signal GSP2 is inputted once in an alternating manner so as to carry out the impulse driving.

As described above, the gate driver 12 can carry out the impulse driving by utilizing a pulse length difference between the start pulse signals GSP (it is not necessary to input the control signal to each gate driver as described in the back ground of the invention). Further, when only the start pulse signal GSP1 is inputted, the gate driver 12 can carry out only the normal display. That is, the gate driver 12 can use a gate driver control signal 14 shared in both the impulse driving and the normal driving (only the normal display).

As a result, when a certain gate driver finishes operating among the gate drivers 12, the gate driver sends an operation completion signal, indicating that the operation has been completed, to a gate driver positioned at a stage following to that gate driver, thereby realizing cascade connection which allows the gate driver at the following stage to begin operating. Further, it is possible to carry out the substrate-less driving which allows the gate driver control signal 14 to be transmitted between the drivers without using the substrate. Thus, as illustrated in FIG. 1, the control circuit 10 has only to supply the gate driver control signal 14 to the gate driver 12 at the first stage.

Further, as described above, the gate driver 12 can use the gate driver control signal shared in both the impulse driving and the normal driving, so that it is possible to easily switch between the impulse driving and the normal driving. Thus, in case of mainly displaying a moving image in a television and the like for example, the impulse driving is carried out. In case of mainly displaying still images in a personal computer and the like for example, the normal display is carried out. In this manner, it is possible to suitably switch the driving mode with ease. As a result, it is possible to improve the display quality with a simple arrangement according to the purpose of use.

Further, as described above, when the start pulse signal GSP2 is inputted, the gate driver 12 sequentially outputs the output signals OG each of which has an H level during the same period as the L period of the image timing signal OE, thereby applying the black signal B to the pixel 1. Thus, by controlling the pulse length of the L period of the image timing signal OE, it is possible to easily control the pulse length of the output signal OG for applying the black signal B to the pixel 1 (i.e., it is possible to easily control a black applying period).

Further, as described above, according to the present embodiment, the driving clock signal rises twice during the H period of the start pulse signal GSP2, so that the output signal OG for applying the black signal B to the pixel 1 twice for each scanning signal line. According to this arrangement, in case where it is impossible to sufficiently apply the black signal B to the pixel 1 (i.e., in case where the black applying period is not sufficient), the start pulse signal GSP2 is changed. Specifically, the number of times the driving clock signal CLS rises in the H period of the start pulse signal GSP2 is changed to three or more (plural number of times). Note that, also the arrangement of the gate driver 12 in this case is included in the technical scope of the present invention.

As a result, the output signal OG for applying the black signal B to the pixel 1 is outputted plural times (three times or more times) for each scanning signal line, so that it is possible to sufficiently apply the black signal B to the pixel 1. Further, as described above, the black applying period can be secured merely by changing the start pulse signal GSP2. Thus, unlike the arrangement (Patent Document 2) in which a switching terminal is provided on each gate driver and an identification signal is provided so as to secure the black applying period (this arrangement is described in the background of the invention), it is possible to secure the black applying period with a simple arrangement.

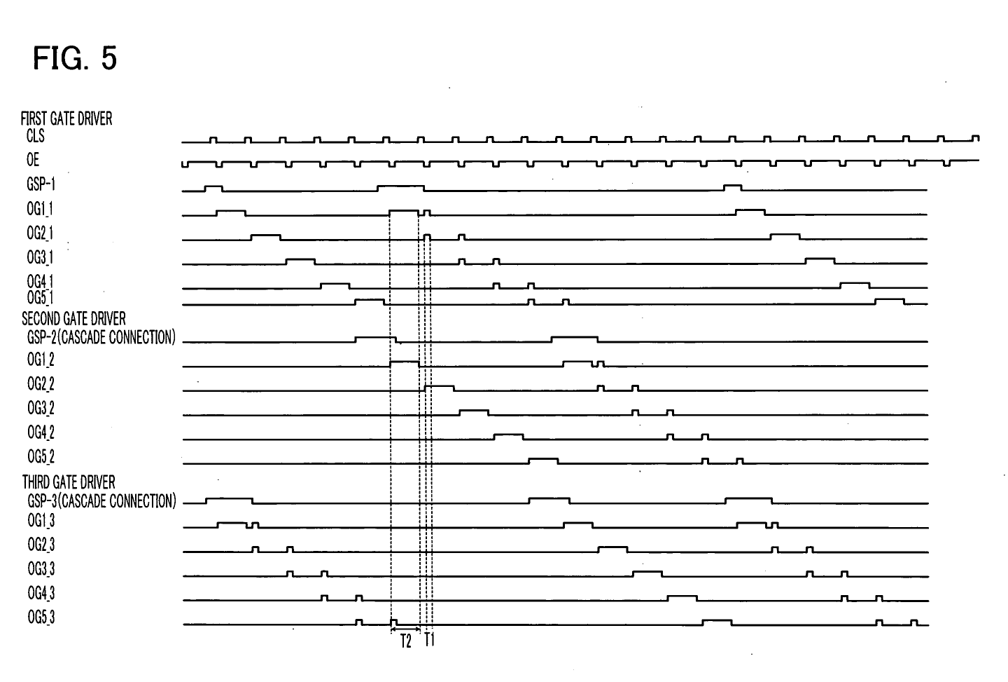

Next, the case of carrying out the impulse driving by using the gate driver 12 is described as follows with reference to FIG. 5. Note that, for convenience in description, the following description explains, as an example, a case where the number of outputs of the gate drivers 12 is simplified, e.g., three gate drivers 12 each of which has five outputs are connected in a cascade manner.

FIG. 5 illustrates operation timings of the gate drivers 12.

As illustrated in FIG. 5, when the start pulse signal GSP1 which is illustrated in FIG. 3 and allows the driving clock signal CLS to rise once in the H period is inputted (to a GSP1-1 in FIG. 5), the first gate driver 12 sequentially outputs the output signals OG1 to OG5 (OG1_1 to OG5_1 in FIG. 5) which are unavailable during the L period of the image timing signal OE and has the H period during the same period as the L period of the driving clock signal CLS, so as to apply the image signal D to the pixel 1 of the liquid crystal panel 5.

Next, at a timing of rise of a driving clock signal CLS previous to a driving clock signal CLS at the time of completion of operation of the first gate driver 12 based on the start pulse signal GSP1, a cascade output (operation completion signal)(transmission of the start pulse signal GSP1)(inputted to GSP_2 of FIG. 5) is outputted from the first gate driver 12 to the second gate driver 12. At this time, the cascade output is outputted at a timing of the start pulse signal GSP1 which allows the driving clock signal CLS rises once during the H period.

As a result, the second gate driver 12 begins operating (upon receiving the start pulse signal GSP1, the second gate driver 12 operates so as to apply the image signal D to the pixel 1). Note that, as illustrated in FIG. 5, also the second gate driver 12 outputs the cascade output so as to continue the operation to the second gate driver 12.

Here, at the time when the first gate driver 12 outputs the cascade output to the second gate driver 12, the first gate driver 12 receives the start pulse signal GSP2 which allows the driving clock signal CLS to rise twice (the start pulse signal GSP2 is inputted to GSP_1 of FIG. 5) during the H period as illustrated in FIG. 4, and accordingly the first gate driver 12 sequentially outputs the output signals OG1 to OG5 (OG1_1 to OG5_1 in FIG. 5) each of which is available during the L period of the image timing signal OE and has the H level during the same period as the L period of the image timing signal OE, so as to apply the black signal B to the pixel 1 of the liquid crystal panel 5. The operation is carried out at this timing, so that the impulse driving is carried out.

Just before completion of the operation of the first gate driver 12 based on the start pulse signal GSP2, as described above, the cascade output is outputted to the second gate driver 12 (transmission of the start pulse signal GSP2), so that the second gate driver 12 begins operating (since the start pulse signal which allows the driving clock signal CLS to rise twice is inputted, the second gate driver 12 operates so as to apply the black signal B to the pixel 1).

For example, during a T1 period in FIG. 5, the H period of the output signal OG of the gate driver 12 (first gate driver 12) which applies the black signal B to the pixel 1 overlaps an H period of an output signal OG of another gate driver 12 (second gate driver 12) which applies the image signal D to the pixel 1. Thus, the black signal B is applied to the pixel 1 connected to a scanning signal line G selected by the second gate driver 12. However, an application period of the image signal D after applying the black signal B is long, so that this raises no problems.

Further, for example, the first gate driver 12 applies the black signal B to the pixel 1 during a T2 period of FIG. 5, but the first signal of the output signal OG1 is unavailable during the L period of the image timing signal OE as described above, so that an output signal having an H level during the same period as the L period of the driving clock signal CLS is outputted. As a result, the image signal D is applied to the pixel 1. However, the second signal of the output signal OG1 causes the black signal B to be applied, so that this is not recognized by the human eyes.

The liquid crystal display device 20 includes the control circuit 10 and the gate drivers 12, so that it is possible to carry out not only the impulse driving but also the cascade connection and the substrate-less driving. Also, it is possible to improve the display quality with a simple arrangement according to the purpose of use.

Note that, in the present embodiment, each of the two types of start pulse signals GSP has a pulse length and a phase which allow the driving clock signal CLS to rise during its H period, but the present invention is not limited to this arrangement. If a circuit arrangement of the gate driver 12 is changed, each of the two types of start pulse signals GSP can have a pulse length and a phase which allow the driving clock signal CLS to drop during its H period. Further, not only the H period but also the L period can be utilized as an active period of the two types of start pulse signals GSP.

Further, in the present embodiment, the driving clock signal CLS rises only once during the H period of the start pulse GSP1, but the present invention is not limited to this arrangement. If a circuit arrangement of the gate driver 12 is changed (more specifically, if the device of the present invention is additionally arranged so as to switch a circuit function of the shift register 21 on the basis of the number of driving clock signals CLS), the start pulse signal GSP1 allows the driving clock signal CLS to rise plural times during the H period for example.

That is, the circuit arrangement of the gate driver 12 is not limited to the arrangement illustrated in FIG. 2. The gate driver 12 may be arranged in any manner as long as it is possible to carry out the impulse driving merely by utilizing the pulse length difference between the start pulse signals. In this case, various arrangements are included in the technical scope of the present invention.

In addition to the foregoing arrangement, it is preferable to arrange the scanning signal line driving device according to the present embodiment when the second start pulse signal is inputted, the scanning signal line driving device turns on the switching element within a period, in which the image signal for causing the pixel to make a dark display is provided to the switching element, so as to define a period, in which the switching element is on, by a pulse length of a signal indicative of a blanking period.

According to the arrangement, a period in which the switching element is on when the second start pulse signal is inputted is defined by a pulse length of the signal indicative of the blanking period. Thus, by controlling the pulse length of the signal indicative of the blanking period, it is possible to control the period in which the switching element is on when the second start pulse signal is inputted. As a result, in addition to the foregoing effect, it is possible to easily control the period in which the pixel makes the dark display.

In addition to the foregoing arrangement, it is preferable to arrange the scanning signal line driving device according to the present embodiment so that the number of times the switching element is turned on when the second start pulse signal is inputted is defined by the number of times the driving clock signal rises or drops during the active period of the second start pulse signal.

According to the arrangement, the number of times the switching element is turned on when the second start pulse signal is inputted is defined by the number of times the driving clock signal rises or drops during the active period of the second start pulse signal. Thus, by controlling the pulse length of the second start pulse signal, it is possible to control the number of times the switching element is turned on when the second start pulse signal is inputted. As a result, in addition to the foregoing effect, it is possible to easily control the period in which the pixel makes the dark display. This arrangement is more effective when used in case where it is impossible to cause the pixel to sufficiently make the dark display merely by controlling the pulse length of the signal indicative of the blanking period.

The present invention is not limited to the description of the embodiments above, but may be altered by a skilled person within the scope of the claims. An embodiment based on a proper combination of technical means disclosed in different embodiments is encompassed in the technical scope of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A scanning signal line driving device, comprising a shift register for shifting an inputted start pulse signal at a timing of an inputted driving clock signal, said scanning signal line driving device controlling a switching element, which becomes on in response to a signal outputted from the shift register and provides a pixel of a display device with an image signal for changing luminance of the pixel, so as to turn on or turn off the switching element, wherein:
the switching element is turned on so as to provide an image signal for displaying an image to the pixel when a first start pulse signal is inputted as the start pulse signal,
the switching element is turned on so as to provide an image signal for causing the pixel to make a dark display to the pixel when a second start pulse signal is inputted as the start pulse signal, and
the driving clock signal rises or drops during an active period of the first start pulse signal, and the driving clock signal rises or drops plural times during an active period of the second start pulse signal.

2. The scanning signal line driving device as set forth in claim 1, wherein when the second start pulse signal is inputted, the scanning signal line driving device turns on the switching element within a period, in which the image signal for causing the pixel to make a dark display is provided to the switching element, so as to define a period, in which the switching element is on, by a pulse length of a signal indicative of a blanking period.

3. The scanning signal line driving device as set forth in claim 1, wherein the number of times the switching element is turned on when the second start pulse signal is inputted is defined by the number of times the driving clock signal rises or drops during the active period of the second start pulse signal.

4. The scanning signal line driving device as set forth in claim 2, wherein the number of times the switching element is turned on when the second start pulse signal is inputted is defined by the number of times the driving clock signal rises or drops during the active period of the second start pulse signal.

5. A liquid crystal display device, comprising a scanning signal line driving device and a control circuit,
said scanning signal line driving device including a shift register for shifting an inputted start pulse signal at a timing of an inputted driving clock signal, wherein:
the scanning signal driving device controls a switching element, which becomes on in accordance with a signal outputted from the shift register so as to provide a pixel of a display device with an image signal for changing luminance of the pixel, so as to provide an image signal for causing the pixel to display an image when a first start pulse signal is inputted as the start pulse signal, and the scanning signal driving device controls the switching element so as to provide an image signal for causing the pixel to make a dark display when a second start pulse signal is inputted as the start pulse signal, and
the driving clock signal rises or drops during an active period of the first start pulse signal, and the driving clock signal rises or drops plural times during an active period of the second start pulse signal,
said control circuit outputting the first start pulse signal and the second start pulse signal to the scanning signal line driving device.

6. The liquid crystal display device as set forth in claim 5, wherein:
when the second start pulse signal is inputted, the scanning signal line driving device turns on the switching element within a period, in which the image signal for causing the pixel to make a dark display is provided to the switching element, so as to define a period, in which the switching element is on, by a pulse length of a signal indicative of a blanking period, and
the control circuit outputs the signal indicative of the blanking period to the scanning signal line driving device as well as the first start pulse signal and the second start pulse signal.

7. The liquid crystal display device as set forth in claim 5, wherein the number of times the switching element is turned on when the second start pulse signal is inputted is defined by the number of times the driving clock signal rises or drops during the active period of the second start pulse signal.

8. The liquid crystal display device as set forth in claim 6, wherein the number of times the switching element is turned on when the second start pulse signal is inputted is defined by the number of times the driving clock signal rises or drops during the active period of the second start pulse signal.

9. A liquid crystal display method for causing a liquid crystal display device to make a display, said liquid crystal display device comprising a scanning signal line driving device and a control circuit,
said scanning signal line driving device including a shift register for shifting an inputted start pulse signal at a timing of an inputted driving clock signal, wherein:
the scanning signal driving device controls a switching element, which becomes on in accordance with a signal outputted from the shift register so as to provide a pixel of a display device with an image signal for changing luminance of the pixel, so as to provide an image signal for causing the pixel to display an image when a first start pulse signal is inputted as the start pulse signal, and the scanning signal driving device controls the switching element so as to provide an image signal for causing the pixel to make a dark display when a second start pulse signal is inputted as the start pulse signal, and
the driving clock signal rises or drops during an active period of the start pulse signal, and the driving clock signal rises or drops plural times during an active period of the second start pulse signal,
said control circuit outputting the first start pulse signal and the second start pulse signal to the scanning signal line driving device,
said liquid crystal display method comprising the steps of:
causing the control circuit to provide only the first start pulse signal to the scanning signal line driving device in carrying out normal driving which allows only an image display; and
causing the control circuit to provide the first start pulse signal and the second start pulse signal alternately to the scanning signal line driving device in carrying out impulse driving which allows the image display and the dark display repeatedly.
